(19) United States
(12) Patent Application Publication
(10) Pub. No.: US 2026/0262838 A1
(43) Pub. Date: Sep. 10, 2026

(54) LEVELING DEVICE

(71) Applicant: AutoStore Technology AS, Nedre Vats (NO)

(72) Inventors: Amund Skålerud, Etne (NO); Børge Bekken, Haugesund (NO)

(21) Appl. No.: 19/166,413

(22) PCT Filed: Mar. 24, 2024
(86) PCT No.: PCT/EP2024/057890

§ 371 Date: Sep. 17, 2025

(30) Foreign Application Priority Data
Mar. 24, 2023 (NO) 20230331

(51) Int. Cl. A47B 96/00; B65G 1/04

(52) U.S. Cl. CPC A47B 96/00; B65G 1/0464

(57) ABSTRACT

There is disclosed a leveling device (10) for leveling a framework structure (100) of an automated storage and retrieval system (1) comprising vertical upright members (102), the leveling device (10) being for insertion at an intermediate height above a base level of the framework structure (100), between an upper upright member segment (102a) and a lower structure, wherein the leveling device comprises: a lower section (14) having a base portion (50) adapted to rest upon the lower structure; an upper section (12) that is vertically movable in relation to the lower section by a variable distance (D) and that has a support surface adapted to support the upper upright member segment (102a); and a wedge-shaped spacer (22) arranged to be laterally inserted between the upper section (12) and the lower section (14) to increase the variable distance (D).

### FIELD

The present disclosure relates to an automated storage and retrieval system for storage and retrieval of containers, in particular to a device for leveling a framework of an automated storage and retrieval system.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

### Framework Leveling

As can be appreciated from the above description, it is important that the framework of an automated storage and retrieval system be level. The upright members 102 need to be in a vertical alignment in order for the storage columns to store stacks of containers properly, and the rail system on which the vehicles travel must be level. Known automated storage and retrieval systems provide this leveling function by so-called leveling feet arranged at the base of the framework, between the upright members 102 and the floor of the facility on which the framework is installed. The leveling feet are height adjustable.

WO 2017/198784 describes a leveling foot having a base section with a raised, hollow column. A spring is arranged in the hollow column. A moveable top piece engages the column and is movable in the vertical direction against the force of the spring. The top piece is slightly larger than the column, such that side walls of the top piece overlap the sides of the column when the spring is compressed. The bottom edges of the side walls of the top piece are angled. A generally U-shaped wedge device is provided that may be pressed into engagement with the base section, whereby a leg of the U engages each side of the column. The top surfaces of the legs of the U-shaped device are angled in the form of wedges, the angles of the top surfaces of the legs corresponding to the angles of the side walls of the movable top piece, such that the side walls of the top piece will rest upon the angled top surfaces of the legs of the wedge device when the top piece is under load.

WO2022/256239 discloses a leveling foot for a grid framework having a base with recess, a column movably disposed in the recess, the column having a receptacle to receive a lower end of an upright member of the grid framework, and a wedge with a sloped surface to adjust the vertical position of the column.

### Intermediate Height Leveling

The devices described in WO 2017/198784 and WO2022/256239 are only usable for adjusting a framework at its base, for example on the floor of the facility in which the framework is installed. In certain situations, however, it would be advantageous to perform the leveling function at a height above the floor of the facility. For example, there may be situations in which one wishes to arrange a first, lower segment of an upright member at the base of the framework, and install a second, upper segment of an upright member above the lower segment. It would be advantageous to be able to level the upper segment independent of the lower segment since the lower segment and structures connected to it may already be level. The devices shown in WO 2017/198784 and WO2022/256239 are unsuited for such an application, as these devices have, inter alia, a cross-sectional shape that would interfere with the vertical movement of containers in storage or port columns. Such a shape is not of consequence when installed at the base of the framework but would be unsuited to be inserted at an intermediate height, for example between upper and lower segments of upright members.

In other situations, it is desirable to insert some other structure or component in an already leveled framework that replaces lower segments of upright members. An example of this includes retrofitting an access station in the framework structure 100. Typically, this requires cutting away a lower segment of upright members 102 in order to fit a port frame for the access station below the remaining upper segments of upright members 102. This cutting must be very accurate to ensure a correct horizontal alignment of the rail system 108 above the upright members 102, and is therefore a tedious and time-consuming operation. In addition, some port frames tend to “sag” and/or come out of alignment during years of operation. Hence, the upper segments of the upright members 102 above the port frame or other structure may require later adjustments.

One way of solving the above problem would be to provide the port frame or other structure with adjustable feet. However, adjusting the feet of the port frame to accommodate inaccurately cut members 102 could result in causing the port frame itself to be unlevel, which may cause problems when operating the access station.

There is therefore a need for a leveling device and method for leveling a framework structure of an automated storage and retrieval system at an intermediate height above the base level of the framework.

### SUMMARY

The present invention is set forth and characterized in the independent claims, while the dependent claims describe other, optional characteristics of the invention.

In one aspect, the disclosure relates to a device for leveling the framework of an automated storage and retrieval system of the type described in the preceding background section. The device according to the present disclosure may be arranged to be inserted at an intermediate height of the framework structure. As used herein, the term “intermediate height” means inserted into the framework at a vertical height that is intermediate the lower ends of the upright members of the framework and the rail system of the framework. According to one aspect, the term “intermediate height” means that the device is inserted between a lower upright member segment and an upper upright member segment. According to another aspect, the term “intermediate height” means that the device is inserted between another structure or body and an upper upright member segment, such as between port frame of an access station and an upper upright member.

According to one aspect, the leveling device according to the disclosure has an upper section with a support surface on which rests an upper upright member segment of the framework and a lower section that rests on a lower structure at an intermediate height, such as a lower upright member segment, or another structure such as a port frame. The upper section is vertically movable in relation to the lower section in order to fill any gap between the upper upright member segment and the lower structure arising when the framework is level. According to one aspect, the device comprises a spacer body arranged between the upper section and the lower section of the device that fills the vertical space between the upper section and the lower section when the upper section is raised so as to level the framework. According to one aspect, the spacer body is a wedge-shaped member.

According to one aspect, the upper section and the lower sections of the leveling device have cooperating guide structures that cooperate to maintain the upper and lower sections in vertical alignment with each other as the upper section is moved vertically in relation to the lower section. According to one aspect, the cooperating guide structures comprise a column piece extending vertically downward from the upper section, and a corresponding recess in the lower section, into which the column piece is inserted. The leveling device of the present disclosure will be described below in relation to this embodiment of the guide structures, however one skilled in the art would recognize that the lower section could comprise the column piece and the upper section could comprise the recess, and the column piece and recess can have any appropriate cross-section, such as circular or rectangular for example.

According to another aspect, the leveling device of the present disclosure has a cross-sectional shape such that, when inserted at an intermediate height, the device does not interfere with the vertical movement of storage containers in a storage or port column of the system. The upright members of the framework comprise corner guide portions for guiding the corners of storage containers that are lifted or lowered by container handling vehicles. According to one aspect, the upper section of the leveling device has a cross-sectional shape essentially corresponding to the cross-sectional shape of the upper upright member segment. According to another aspect, the cross-sectional shape of the upper section of the device includes portions essentially corresponding to the cross-sectional shape of the corner guides of the upright members.

In one aspect, the lower section of the leveling device has a cross-sectional shape essentially corresponding to an upright member segment, including in a preferred embodiment a cross-sectional shape having a portion essentially corresponding to the cross-sectional shape of the corner guides of an upright member. This embodiment of the device is particularly useful when an upper upright member segment is to be arranged above a lower upright member segment. In such a case, it is important that both the upper and lower sections of the leveling device have a cross-sectional shape that does not interfere with the vertical movement of containers in a storage column, and preferably have cross-sectional shapes with portions corresponding to the corner guides of the upright member segments.

According to one aspect, the upper and lower sections of the leveling device have corresponding sloped edges that rest upon each other when the upper section is in the lowermost position relative to the lower section. In a preferred embodiment, the lower section has a groove or slot for receiving a wedge member that is inserted laterally into the lower section that raises the upper section against the sloped upper surface of the wedge. In one aspect, the wedge member is U-shaped, with wedge-shaped legs. The wedge-shaped member preferably has a slope that corresponds with the slope of the edges of the upper and/or lower sections of the device. According to one aspect, the U-shaped wedge member has locking teeth along the surface of the legs that engage with corresponding teeth in the lower section or the upper section.

According to another embodiment, the lower section has a shape particularly adapted to the structure or body on which the device is to be mounted, and according to one aspect the lower section of the device has a cross-sectional size that is smaller than the cross-sectional size of the upper section of the device, such that the lower section of the device does not protrude into the path of a vertically moving container.

According to one aspect, the leveling device of the present disclosure may be described as follows:

A leveling device for leveling a framework structure comprising vertical upright members at an intermediate height between an upper upright member segment and a lower structure intermediate a floor of a facility in which the framework structure is erected and the upper upright member segment, wherein the leveling device comprises:
a. a lower section,
b. an upper section that is vertically movable in relation to the lower section by a variable distance (D),
c. wherein the upper section has a cross-sectional shape that corresponds to the cross-sectional shape of the upper upright member segment,
d. the lower section has a base portion adapted to rest upon the lower structure,
e. a wedge-shaped spacer arranged to be laterally inserted between the upper section (and the lower section).

According to another aspect, there is disclosed an automated storage and retrieval system comprising a framework structure comprising a plurality of upright members arranged in rows in a grid pattern, whereby a plurality of sets of four adjacent upright members define storage columns for storing stacks of storage containers, a rail system supported by the upright members, on which rail system a plurality of container handling vehicles are operated, the vehicles having a gripping device for raising and lowering storage containers into and out of the storage columns, and wherein the upright members have a cross-sectional profile that defines corner guide portions for guiding and retaining corners of the storage containers, thereby retaining the containers within the vertical confines of a storage column during a raising or lowering operation, CHARACTERIZED IN THAT that framework structure (one or more upper upright member segments arranged above a lower structure that is intermediate a floor of a facility in which the framework is erected and the upper upright member segment, and where in a leveling device as described above is inserted between the upper upright member segment and the lower structure.

According to yet another aspect, there is disclosed a method for leveling a framework structure of an automated storage and retrieval system at an intermediate height, comprising
a. arranging a leveling device as described above at an intermediate height between an upper upright member segment and a lower structure intermediate a floor of a facility in which the framework structure is erected and the upper upright member segment, and
b. laterally inserting wedge-shaped spacer in order to change variable distance (D) so as to fill any gap airing between upper upright member segment and the lower structure when the framework is brought level.

### BRIEF DESCRIPTION OF THE DRAWINGS

Following drawings are appended to facilitate understanding of the disclosure. The drawings show embodiments, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a perspective view of an embodiment of the device according to the present disclosure.

FIG. 6 is a perspective, partially exploded view of FIG. 6.

FIG. 7 is a perspective view of a wedge-shaped member.

FIG. 8 is a perspective, exploded view of a leveling device according to one aspect of the present disclosure inserted between lower and upper upright member segments.

FIG. 9a illustrates a side view of a framework structure with a port frame, wherein one upper upright member segment is too short, causing a gap between the rail system and the upper upright member segment.

FIG. 9b illustrates a side view of a framework structure with a port frame, wherein a leg of the port frame has been adjusted by means of a prior art levelling foot, causing an unlevelled port frame.

FIG. 9c illustrates the result of using the device of the present disclosure between the port frame and the upper upright member segments.

FIG. 10 conceptually illustrates the device of the present disclosure inserted between a port frame and upper upright member segments of a framework structure.

FIG. 11 is an exploded view an embodiment of the device of the present disclosure inserted between a narrow column and an upper upright member segment of a framework structure, for example as illustrated in FIG. 10.

FIG. 12 illustrates an alternate embodiment of the device of the present disclosure, with an alternate form of a lower section of the device.

### DETAILED DESCRIPTION

In overview, the disclosure relates to a leveling device for leveling a framework structure of an automated storage and retrieval system comprising vertical upright members. The leveling device is for insertion at an intermediate height above a base level of the framework structure, more specifically between an upper upright member segment and a lower structure. The leveling device comprises a lower section having a base portion (50) to rest upon the lower structure, an upper section that is vertically movable in relation to the lower section by a variable distance D and that has a support surface to support an upper upright member segment of the framework structure, and a wedge-shaped spacer to be laterally inserted between the upper section and the lower section to increase the variable distance D. The cross-sectional shape of the leveling device may match that of the vertical upright members, and may be a shape (e.g., that of a cross) that does not interfere with, or even guides, storage containers as they move vertically past the leveling device.

In the following, embodiments will be discussed in more detail with reference to the appended drawings. It should be understood, however, that the drawings are not intended to limit the disclosure to the subject-matter depicted in the drawings.

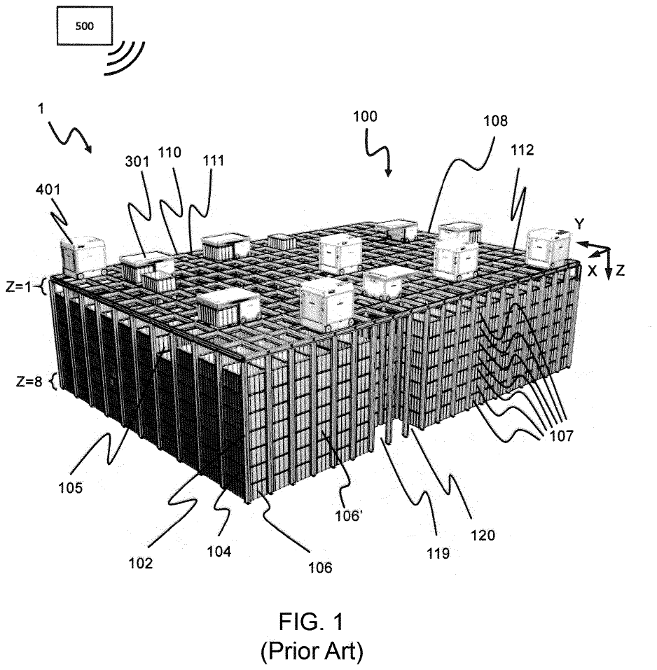

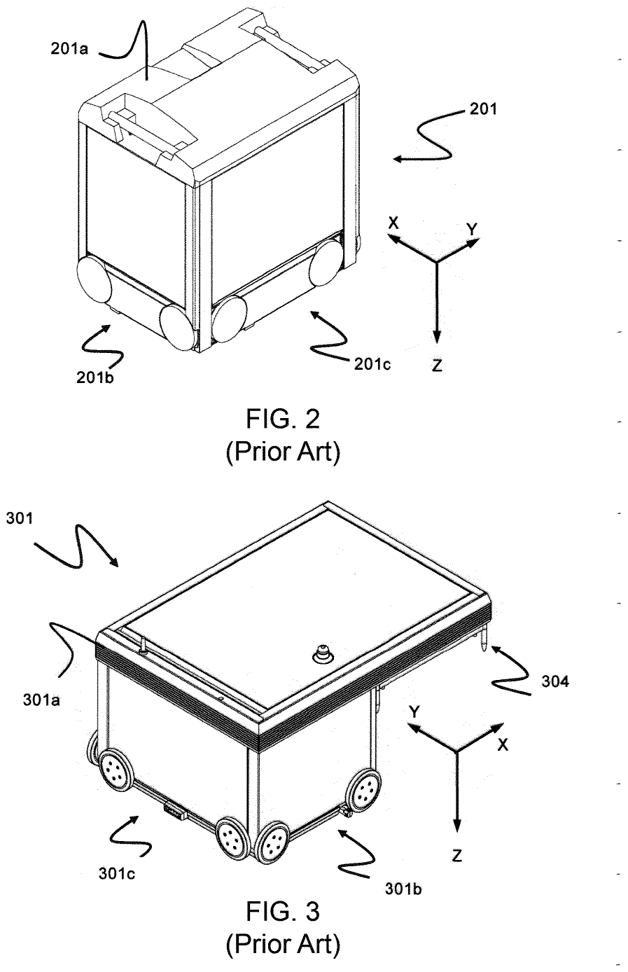

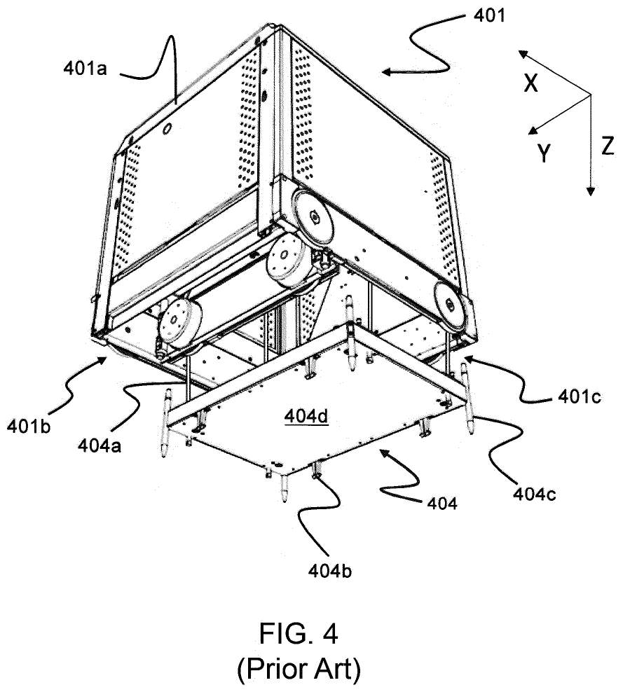

The disclosure relates to a leveling device and method for use in an automated storage and retrieval system, including framework structure 100, as described above in connection with FIGS. 1-4. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

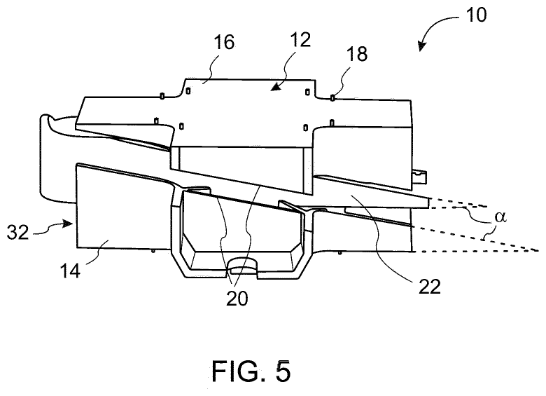

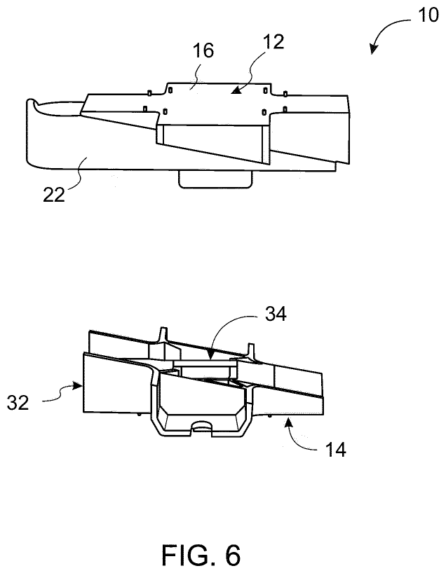

The leveling device of the present disclosure, a storage and retrieval system comprising the device, and a method of using the device to level a framework in an automated storage and retrieval system will now be discussed in more detail with reference to FIGS. 5-12.

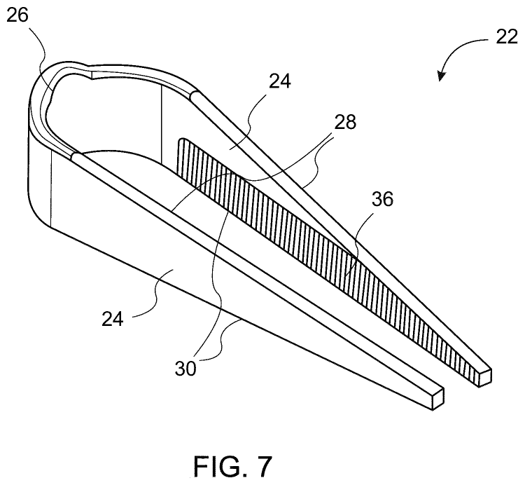

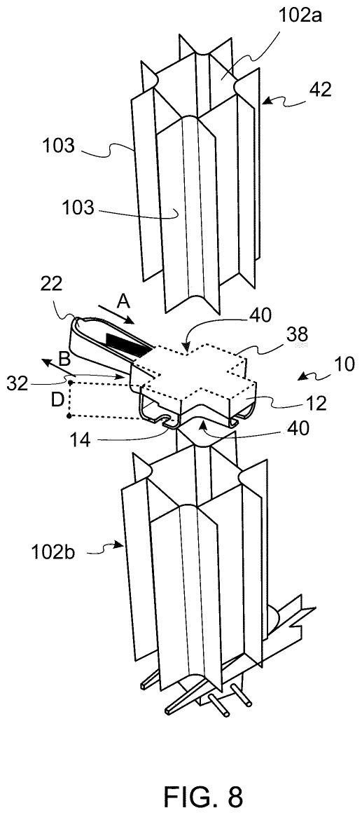

FIGS. 5-7 illustrate a first embodiment of the leveling device 10 according to the present disclosure. The device comprises an upper section 12 and a lower section 14. Upper section 12 has a support surface 16 arranged to support an upper upright member segment 102a as shown in FIGS. 8, 10 and 11. According to one aspect, support surface 16 may be equipped with alignment pins 18, arranged to engage internal portions of an extruded upright segment 102a, and thereby align the upright member segment on the support surface 16. According to an aspect of this embodiment, upper section 12 and lower section 14 have corresponding sloped edges 20 having a slope angle α, whereby the sloped edges rest upon each other when upper section 12 is in a lowermost position in relation to lower section 14. The device also comprises a wedge-shaped spacer 22 arranged to be laterally inserted between the upper and lower sections of the device in order to separate the upper section from the lower section by a variable distance D depending upon the lateral position of the wedge-shaped spacer 22. Wedge-shaped spacer 22 has a sloped surface 28 with a corresponding slope angle α. A preferred embodiment of wedge-shaped spacer 22 is illustrated in FIG. 7. According to this embodiment, spacer 22 is a U-shaped wedge member having two legs 24 and a rear connection portion 26. Legs 24 have sloped upper surfaces 28 and horizontal lower edges 30. Wedge-shaped spacer 22 is arranged to be inserted into a lateral opening 32 between the upper and lower sections, as shown in FIGS. 5, 6 and 8. Opening 32 is preferably connected to slots or grooves 34 arranged to guide legs 24 into opening 32. In a preferred embodiment, legs 24 are equipped with locking teeth 36 for lockingly engaging with an internal portion of opening 32 and/or slot 34, in order to retain the wedge-shaped spacer in a particular position when under load.

The leveling device 10 is arranged to be inserted at an intermediate height in framework structure 100, in particular at a position between a lower structure and an upper upright member segment 102a as shown in FIGS. 8, 9a, 9b, 9c, 10 and 11, and more particularly at an intermediate height in connection with a storage or port column in which containers will be vertically raised or lowered. In as much as containers will be raised or lowered in the column past the leveling device, the leveling device has a cross-sectional shape that does not interfere with the vertical movement of containers in the column. In one aspect, as shown in FIG. 8, the leveling device 10 has a cross-sectional shape 38 that essentially corresponds to the cross-sectional shape of upper upright member segment 102a. As shown in FIG. 8, prior art upper upright member segments 102a comprise corner guide profiles 103. The cross-sectional shape 38 of leveling device 10 according to one aspect has corner portions 40 that corresponds with corner guide profiles 103. One example of such a cross-sectional shape is that of a cross as shown in FIG. 8, however it should be understood that the cross-sectional shape 38 could be a different shape if the upright member segment has a different shape. As used herein, the term “corresponds with corner guide profiles 103” means that the size and shape of corner portion 40 of the leveling device essentially matches with the size and shape of a container-guiding corner 42 formed by corner guide profiles 103. Thus, the corner portion 40 of the leveling device will permit containers to be raised and lowered past the device, and the corner portion 40 will also perform as a guide for containers that move vertically past the device in the same manner as container-guiding corner 42.

The embodiment of the device shown in FIG. 8 is particularly suited for a method of leveling a framework 100 comprising inserting leveling device 10 between an upper upright member segment 102a, and a lower upright member segment 102b. According to this embodiment, both upper section 12 and lower section 14 of the leveling device have cross-sectional shape 38.

As shown in FIG. 8, when wedge-shaped spacer 22 is inserted laterally into the device in direction A, the upper section of the device will be raised, thereby increasing variable distance D, and when wedge-shaped spacer 22 is withdrawn in direction B variable distance D will decrease.

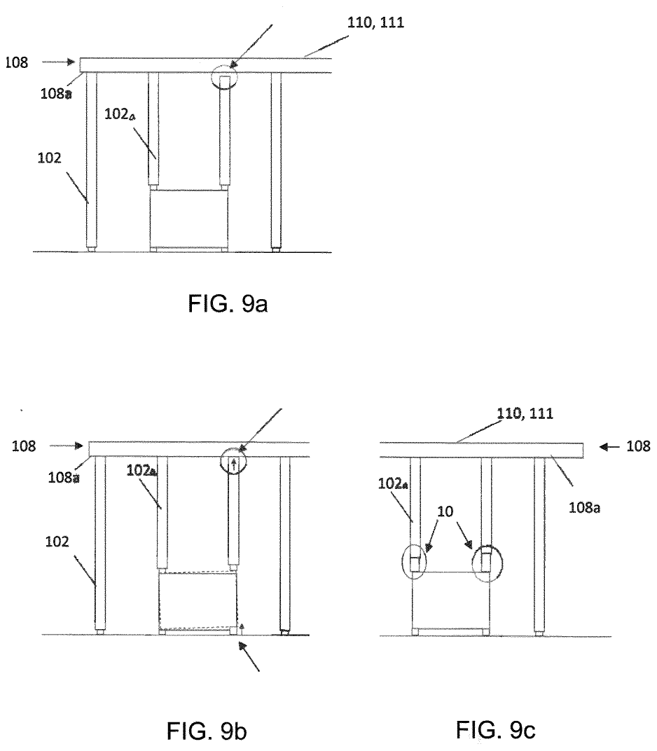

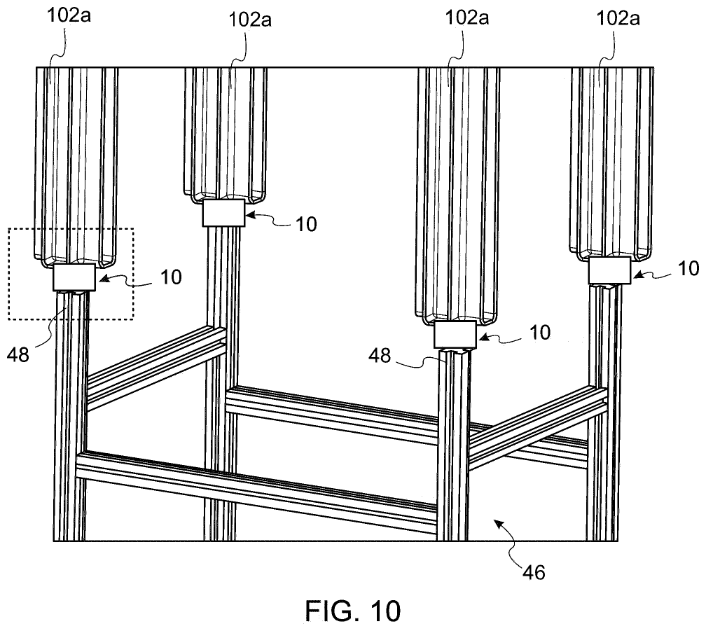

FIGS. 9b and 10 conceptually illustrate an aspect of a leveling device 10 arranged to be inserted between upper upright member segment 102a and a lower structure. This aspect of the disclosure will be described in connection with the lower structure being a port frame 46, however one skilled in the art will recognize that the lower structure could be some other type of structure. As shown in FIG. 10, a port frame 46 often comprises vertically extending port frame posts 48, which are often narrower than upright member segment 102a.

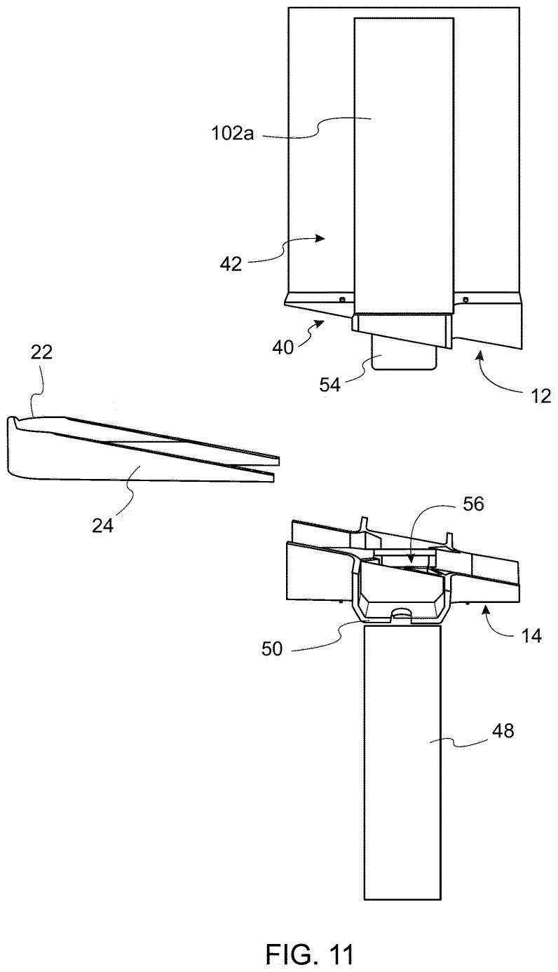

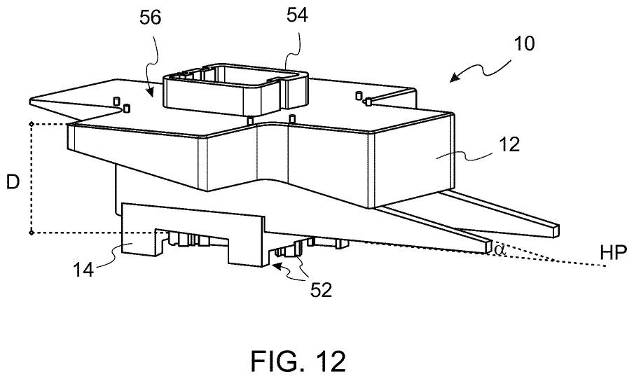

FIG. 11 illustrates a method of using the device shown in FIGS. 5-7 between upper upright member segment 102a and port frame post 48. In one aspect, the embodiment shown in FIGS. 5-7 can be utilized by resting a base portion 50 of lower section 14 on top of port frame post 48. FIG. 12 illustrates an embodiment of the leveling device 10 where lower section 14 of the device has a shape particularly adapted to the structure on which it is to rest. As shown in FIG. 12, lower section 14 has a cross-sectional shape with a profile corresponding to the cross-sectional shape of the port frame post, here shown with notches and/or protrusions 52 adapted to lockingly engage with the top of port frame post 48. According to one aspect, lower section 14 has a cross-sectional area that is smaller than the cross-sectional area of the upper section 12. As used in this context, the term “smaller than” means that the cross-sectional area of the lower section 14 of the device will be within a peripheral boundary defined by a downward projection of the cross-sectional area of the upper section 12, such that no portions of the lower section protrudes past the peripheral boundary of the downward projection of the cross-sectional shape of the upper section 12. In other words, when viewed from directly above upper section 12, no portion of lower section 14 would be visible beyond the outer edges of the upper section.

According to another aspect of the present disclosure, the leveling device 10 comprises cooperating guide structures that cooperate to maintain the upper and lower sections 12, 14 in vertical alignment with each other as the upper section is moved vertically in relation to the lower section. According to one aspect shown in FIGS. 5-7 and 11, the cooperating guide structures comprise a column piece 54 extending vertically downward from upper section 12, and a corresponding recess 56 in the lower section 14, into which the column piece is inserted. Column piece 54 is preferably longer that the maximum operative vertical height of legs 24 of the wedge-shaped spacer 22 so that column piece 54 remains within recess 56 when the variable distance D is at its greatest. FIG. 12 illustrates an embodiment where column piece 54 extends vertically from lower section 14 and recess 56 is arranged in upper section 12.

In the preceding description, various aspects of the leveling device and the automated storage and retrieval system according to the present disclosure have been described with reference to the illustrative embodiments. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention, which is defined by the appended claims.

Aspects and features of the present disclosure are set out in the following numbered clauses.
1. A leveling device (10) for leveling a framework structure (100) comprising vertical upright members (102) at an intermediate height between an upper upright member segment (102a) and a lower structure intermediate a floor of a facility in which the framework structure is erected and the upper upright member segment, wherein the leveling device comprises:
   a. a lower section (14),
   b. an upper section (12) that is vertically movable in relation to the lower section by a variable distance (D),
   c. wherein the upper section has a cross sectional shape that corresponds to the cross-sectional shape of the upper upright member segment (102a),
   d. the lower section has a base portion (50) adapted to rest upon the lower structure,
   e. A wedge-shaped spacer arranged to be laterally inserted between the upper section (12) and the lower section (14).
2. The leveling device according to clause 1, wherein the lower structure is a lower upright member segment 102(b), and the wherein the lower section (14) of the leveling device has a cross-sectional shape corresponding to the cross-sectional shape of the lower upright member segment (102b).
3. The leveling device according to clause 1, wherein the lower structure comprises an upwardly projecting post (48) that is narrower than the upper upright member segment (102a), wherein the base section has portions (52) that engage a top of the post (48) and the lower section has a cross sectional area that is than the cross-sectional area of the upper upright member segment.
4. The leveling device according to one of the preceding clauses wherein the wedge-shape spacer is a U-shaped member having legs (24) with sloped upper surfaces (28) and wherein the upper section (12) has a corresponding sloped surface (20) arranged to be supported by the sloped surface of the wedge-shaped spacer.
5. The leveling device according to clause 4, wherein the legs (24) have locking teeth (36) arranged to lockingly engage with corresponding locking teeth 36 arranged on either the upper section (12) of lower section (14).
6. The leveling device according to one of the preceding clauses wherein the device comprises a vertical guide structure in the form of a column piece arranged on either the upper or lower section of the device, and a cooperating recess into which the column piece is inserted, arranged on the remaining section.
7. An automated storage and retrieval system (1) comprising a framework structure (100) comprising a plurality of upright members (102) arranged in rows in a grid pattern, whereby a plurality of sets of four adjacent upright members define storage columns (105) for storing stacks of storage containers (106), a rail system (108) supported by the upright members, on which rail system a plurality of container handling vehicles are operated, the vehicles having a gripping device for raising and lowering storage containers into and out of the storage columns, and wherein the upright members have a cross sectional profile that defines corner guide portions (103) for guiding and retaining corners of the storage containers, thereby retaining the containers within the vertical confines of a storage column during a raising or lowering operation, CHARACTERIZED IN THAT that framework structure (100) one or more upper upright member segments (102a) arranged above a lower structure that is intermediate a floor of a facility in which the framework is erected and the upper upright member segment, and where in a leveling device according to any one of clauses 1-6 is inserted between the upper upright member segment and the lower structure.
8. The automated storage and retrieval system according to clause 7, wherein the upper upright member segment (102b) in in connection with a storage column (105) or port column (119, 120) in which containers are moved vertically, and wherein the cross sectional shape of the upper section (12) and lower section (14) of the device do not interfere with the vertical movement of the containers in the column.
9. The automated storage and retrieval system according to clause 8, wherein the upper upright member segment (102a) comprises one or more corner guide portions (103) having a container-guiding corner (42) for guiding the corners of storage containers (106) as the move vertically along the upper upright member segment, and wherein the upper section (12) of the leveling device has a cross-sectional shape that comprises a corner portion (40) that corresponds the container-guiding corner (42 of the upper upright member segment.
10. The automated storage and retrieval system according to one of clauses 7-9, wherein the lower structure is a port frame (46) with one more port frame posts (48) upon which rest the lower section (14) of the leveling device (10).
11. A method for leveling a framework structure (100) of an automated storage and retrieval system at an intermediate height, comprising
   a. arranging a leveling device according to one of clauses 1-6 at an intermediate height between an upper upright member segment (102a) and a lower structure intermediate a floor of a facility in which the framework structure is erected and the upper upright member segment, and
   b. laterally inserting wedge-shaped spacer (22) in order to change variable distance (D) so as to fill any gap airing between upper upright member segment (102a) and the lower structure when the framework is brought level.
12. The method according to clause 11, wherein the lower structure is a port frame (46).
13. The method according to clause 12, wherein upper upright member segment (102a) is formed by cutting an upright member (102) of the framework in order to create space for the insertion of the port frame into the framework structure.

### LIST OF REFERENCE NUMBERS

Prior art (FIGS. 1-4):
1 Prior art automated storage and retrieval system
100 Framework structure
102 Upright members of framework structure
102a Upper upright member segment
102b Lower upright member segment
103 Corner guide portion
104 Storage grid
105 Storage column
106 Storage container
106′ Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
X First direction
Y Second direction
Z Third direction
10 Leveling device
12 Upper section of the leveling device
14 Lower section of the leveling device
16 Support surface 16
18 Alignment pins
20 Sloped edges
22 Wedge-shaped spacer
24 Legs
26 Rear connection portion
28 Sloped upper surface
30 Horizontal edges
32 Lateral opening
34 Groove or slot
36 Locking teeth
38 Cross-sectional shape
40 Corner portion of the device
42 Container-guiding corner
46 Port frame
48 Port frame post
50 Base portion
52 Notches or protrusions
54 Column piece
56 Recess

1-19. (canceled)

20. A leveling device for leveling a framework structure of an automated storage and retrieval system comprising vertical upright members, the leveling device being for insertion at an intermediate height above a base level of the framework structure, between an upper upright member segment and a lower structure, wherein the leveling device comprises:
a lower section having a base portion adapted to rest upon the lower structure;
an upper section that is vertically movable in relation to the lower section by a variable distance and that has a support surface adapted to support the upper upright member segment; and
a wedge-shaped spacer arranged to be laterally inserted between the upper section and the lower section to increase the variable distance.

21. The leveling device of claim 20, wherein the lower structure is intermediate a floor of a facility in which the framework structure is erected and the upper upright member segment.

22. The leveling device of claim 20, wherein the upper section has a cross-sectional shape that corresponds to a cross-sectional shape of the upper upright member segment.

23. The leveling device of claim 20, wherein a cross-sectional shape of the leveling device is that of a cross.

24. The leveling device of claim 20, wherein the leveling device has a cross-sectional shape that comprises one or more corner portions for guiding storage containers as they move vertically past the leveling device.

25. The leveling device of claim 20, wherein the lower structure is a lower upright member segment, and wherein the lower section of the leveling device has a cross-sectional shape corresponding to the cross-sectional shape of the lower upright member segment.

26. The leveling device of claim 20, wherein the lower structure comprises an upwardly projecting post that is narrower than the upper upright member segment, wherein the base portion has portions that engage a top of the post and the lower section has a cross-sectional area that is smaller than that of the upper section.

27. The leveling device of claim 20, wherein the wedge-shaped spacer is a U-shaped member having legs with sloped upper surfaces and wherein the upper section has a corresponding sloped surface arranged to be supported by the sloped surface of the wedge-shaped spacer.

28. The leveling device of claim 27, wherein the legs have locking teeth arranged to lockingly engage with corresponding locking teeth arranged on either the upper section or the lower section.

29. The leveling device of claim 20, wherein the device comprises a vertical guide structure in the form of a column piece arranged on one of the upper section or lower section of the device, and a cooperating recess into which the column piece is inserted, the recess being arranged on the other of the upper section or lower section.

30. An automated storage and retrieval system comprising a framework structure and the leveling device of any preceding claim.

31. The automated storage and retrieval system of claim 30, wherein the vertical upright members are arranged in rows in a grid pattern, whereby a plurality of sets of adjacent upright members define storage columns for storing stacks of storage containers, and wherein the upright members have a cross-sectional profile that defines corner guide portions for guiding and retaining corners of the storage containers, thereby retaining the storage containers within the vertical confines of a storage column, wherein the framework structure comprises an upper upright member segment arranged above a lower structure that is intermediate a floor of a facility in which the framework structure is erected and the upper upright member segment, and wherein the leveling device is between the upper upright member segment and the lower structure.

32. The automated storage and retrieval system of claim 31, wherein the automated storage and retrieval system further comprises a rail system supported by the vertical upright members, on which rail system a plurality of container handling vehicles can operate, the container handling vehicles having a gripping device for raising and lowering storage containers into and out of the storage columns, the storage containers being retained within the vertical confines of a storage column during a raising or lowering operation, and the plurality of sets of adjacent upright members optionally comprising a plurality of sets of four adjacent upright members.

33. The automated storage and retrieval system of claim 31, wherein the upper upright member segment is in connection with a storage column or port column in which storage containers are arranged to move vertically, and wherein the cross-sectional shape of the upper section and the lower section of the device do not interfere with the vertical movement of the storage containers in the column.

34. The automated storage and retrieval system of claim 33, wherein the upper upright member segment comprises one or more corner guide portions having a container-guiding corner for guiding the corners of storage containers as they move vertically along the upper upright member segment, and wherein the upper section of the leveling device has a cross-sectional shape that comprises a corner portion that corresponds the container-guiding corner of the upper upright member segment.

35. The automated storage and retrieval system of claim 31, wherein the lower structure is a port frame with one or more port frame posts upon which the lower section of the leveling device rests.

36. A method for leveling a framework structure of an automated storage and retrieval system at an intermediate height, comprising:
arranging the leveling device of any of claims 1 to 10 at an intermediate height between an upper upright member segment and a lower structure, the lower structure being intermediate a floor of a facility in which the framework structure is erected and the upper upright member segment, and
laterally inserting the wedge-shaped spacer in order to change the variable distance so as to fill any gap between upper upright member segment and the lower structure when the framework structure is brought level.

37. The method of claim 36, wherein the lower structure is a port frame.

38. The method of claim 37, wherein upper upright member segment is formed by cutting an upright member of the framework structure in order to create space for the insertion of the port frame into the framework structure.
